(19) United States
(12) Patent Application Publication
(10) Pub. No.: US 2005/0182628 A1
(43) Pub. Date: Aug. 18, 2005

(54) Domain-based dialog speech recognition method and apparatus

(75) Inventor: Injeong Choi, Gyeonggi-do (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/059,354

(22) Filed: Feb. 17, 2005

(30) Foreign Application Priority Data
Feb. 18, 2004 (KR) 10-2004-0010659

(51) Int. Cl. G10L 15/00

(52) U.S. Cl. 704/252

(57) ABSTRACT

A domain-based speech recognition method and apparatus, the method including: performing speech recognition by using a first language model and generating a first recognition result including a plurality of first recognition sentences; selecting a plurality of candidate domains, by using a word included in each of the first recognition sentences and having a confidence score equal to or higher than a predetermined threshold, as a domain keyword; performing speech recognition with the first recognition result, by using an acoustic model specific to each of the candidate domains and a second language model and generating a plurality of second recognition sentences; and selecting at least one or more final recognition sentence from the first recognition sentences and the second recognition sentences. According to this method and apparatus, the effect of a domain extraction error by misrecognition of a word on selection of a final recognition result can be minimized.

### CROSS-REFERENCE TO RELATED APPLICATION

This application claims the priority of Korean Patent Application No. 2004-10659, filed on Feb. 18, 2004 in the Korean Intellectual Property Office, the disclosure of which is incorporated herein by reference.

### BACKGROUND OF THE INVENTION

1. Field of the Invention

The present invention relates to speech recognition, and more particularly, to a domain-based dialog speech recognition method and apparatus, which can minimize what domain detection error, induced by misrecognition of a word, affects the ultimate recognition results.

2. Description of the Related Art

Speech recognition system is a device which takes a speech signal, parameterizes the speech signal into a sequence, and then processes the sequence to produce a hypothesis of the sequence of word or phoneme in the speech signal.

Recently, a large number of methods have been introduced to improve the performance of dialog speech recognition. For example, “Speech recognition method using speech act information”, disclosed in Korean Patent No. 277690, describes the use of speech act information. In this method, a speech act is estimated based on the recognized hypothesis. Subsequently, with the language model inferred by the estimated speech act, speech recognition is performed. However, according to this method, because of an error accompanying the recognition result obtained in the first speech recognition process, if there is a speech act estimation error, it is highly probable that an incorrect final recognition result is obtained.

Another example of speech recognition widely used is domain-based speech recognition. In this method, acoustic and language models, which are specific to domain such as weather, travel, and so on, are established. And with these models, speech recognition is performed. But, this method requires heavy computational load since speech recognition systems as well as a number of domains run in parallel to obtain the best recognition result with the highest confidence score among the multiple recognition results. As a remedy of this problem, an alternative method is proposed. In the first phase, keywords are detected in line with input utterance. In the next phase, speech recognition is performed with domains inferred by the detected keywords. However, this method also causes a problem in that the accuracy of speech recognition is too sensitive to a domain extraction error. For example, if wrong keywords are detected in the first phase, dramatic performance degradation occurs in the speech recognition at the second phase since the wrong keywords run with improper domain knowledge, that is, acoustic and language model due to wrong keywords. In addition, if a spoken sentence includes a keyword corresponding to at least two domains, it is difficult to identify one domain among the plurality of domains.

### SUMMARY OF THE INVENTION

According to an aspect of the present invention, there is provided a domain-based dialog speech recognition method and apparatus, which can minimize what domain detection error, induced by misrecognition of a word, affects the ultimate recognition results.

According to another aspect of the present invention, there is provided a domain-based dialog speech recognition method including: performing speech recognition by using a first language model and generating a plurality of first recognition sentences and word lattice; selecting a plurality of candidate domains, by using a word included in each of the first recognition sentences and having a reliability equal to or higher than a predetermined threshold, as a domain keyword; performing speech recognition in the word lattice, by using an acoustic model specific to each of the candidate domains and a second language model and generating a plurality of second recognition sentences; and selecting one or more final recognition sentences from the first recognition sentences and the second recognition sentences.

According to another aspect of the present invention, there is provided a domain-based dialog speech recognition apparatus including: a first speech recognition unit which performs speech recognition of input speech by using a first language model and generates a first recognition result including a plurality of first recognition sentences; a domain extraction unit which selects a plurality of candidate domains by using the plurality of first recognition sentences provided by the first speech recognition unit; a second speech recognition unit which performs speech recognition with the recognition result of the first speech recognition unit, by using an acoustic model specific to each of candidate domains selected in the domain extraction unit and a second language model and generates a plurality of second recognition sentences; and a selection unit which selects a plurality of final recognition sentences from the first recognition sentences provided by the first speech recognition unit and the second recognition sentences provided by the second speech recognition unit.

According to another aspect of the invention, the method can be implemented by a computer-readable recording medium having embodied thereon a computer program for the method.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram showing an embodiment of a domain-based dialog speech recognition apparatus according to an embodiment of the present invention;

FIG. 2 is a block diagram showing a detailed structure of a first speech recognition unit in FIG. 1;

FIG. 3 is a block diagram showing a detailed structure of a domain extraction unit in FIG. 1;

FIG. 4 is a block diagram showing a detailed structure of a second speech recognition unit in FIG. 1; and

FIG. 5 is a flowchart of the operations performed by a domain-based speech recognition method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

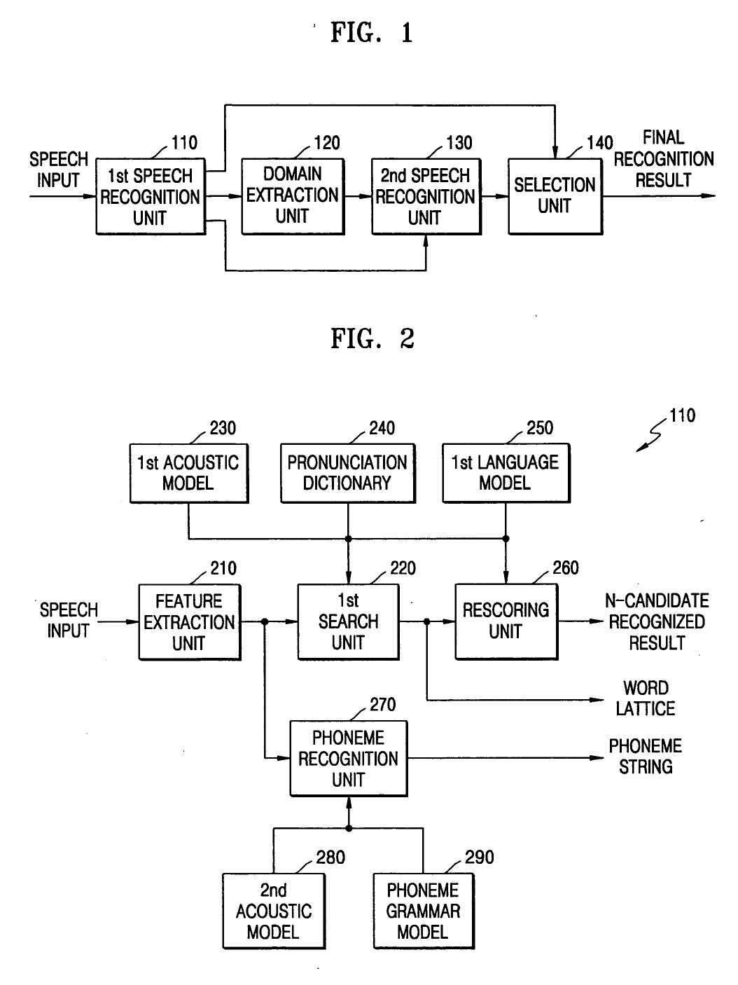

As shown in FIG. 1, an embodiment of a domain-based dialog speech recognition apparatus according to the present invention includes a first speech recognition unit 110, a domain extraction unit 120, a second speech recognition unit 130, and a selection unit 140.

Referring to FIG. 1, the first speech recognition unit 110 performs speech recognition with an input speech signal through a feature extraction, the Viterbi searching, and rescoring, and as a result, generates a first recognition result. The Viterbi searching is performed based on one language model, which is switched on among a plurality of generalized language models established from the entire training set, an acoustic model, and a pronunciation dictionary.

As examples of generalized language models, there are a global language model (LM) covering an entire domain, a speech act specific LM on system speech contents, and a prompt specific LM, but the generalized language models are not limited to these examples. In speech recognition, in the initial stage, a global language model is used, and as the conversion proceeds, the global language model is used as is, or depending on dialog situations, the global language model is dynamically switched to an appropriate language model among the plurality of language models. As examples of switching criteria, there are the dialog history of a user and a system, speech act information on system speech contents, and information on prompt categories. This information is fed back to the first speech recognition unit 110 from a dialog management unit (not shown) in a dialog speech system between a user and a system.

The first recognition result generated in the first speech recognition unit 110 includes word lattices obtained as the result of the Viterbi searching and high-level N recognition sentences obtained as the result of the rescoring. In addition to the word lattices, word graphs are also obtained by compactly compressing word lattices. Meanwhile, when a process for recognizing phonemes is added in order to measure reliability of the speech recognition result, a phoneme string may be further included in the first recognition result. Instead of phoneme recognition, a syllable recognition, which has relatively higher recognition accuracy, can also be used. Among the first recognition results, high-level N recognition sentences are provided to the domain extraction unit 120 and the selection unit 140, the word lattices or word graphs are provided to the domain extraction unit 120 and the second speech recognition unit 130, and the phoneme string is provided to the domain extraction unit 120.

The domain extraction unit 120 receives inputs of the high-level N recognition sentences, the word lattices, and the phoneme recognition result among the first recognition results generated in the first speech recognition unit 110, calculates a word-level confidence score, selects domain keywords among words each having a confidence score equal to or greater than a predetermined threshold, and extracts candidate domains based on the selected domain keywords and domain knowledge. A domain classifier used to select a candidate domain is a simple statistical classifier using the domain probability of a keyword, or a support vector machine (SVM) classifier, and determines all the domains that have the domain classification scores within a predetermined range including the highest classification score, as candidate domains.

The second speech recognition unit 130, by using an acoustic model and a language model corresponding to each candidate domain extracted in the domain extraction unit 120, again performs speech recognition with the word lattices provided by the first speech recognition unit 110, and as the result, generates a plurality of recognition sentences.

The selection unit 140 receives the high-level N recognition sentences obtained as the result of speech recognition in the first speech recognition unit 110 and the plurality of recognition sentences obtained as the result of speech recognition in the second speech recognition unit 130, and selects a plurality of high-level recognition sentences among the received sentences. Then, the selection unit 140 provides word-level and sentence-level confidence scores of each of the high-level recognition sentences and the domain of each recognition sentence, as the final recognition result.

FIG. 2 is a block diagram showing a detailed structure of the first speech recognition unit 110 in FIG. 1. The first speech recognition unit 110 includes a feature extraction unit 210, a first search unit 220, a rescoring unit 260, and a phoneme recognition unit 270.

Referring to FIG. 2, the feature extraction unit 210 receives a speech signal input, and converts the speech signal input into feature vectors useful for speech recognition, such as a Mel-Frequency Cepstral coefficient.

The first search unit 220 receives the feature vectors from the feature extraction unit 210, and by using a first acoustic model 230, a pronunciation dictionary 240, and a first language model 250 that are obtained in advance in the learning process, finds a word string in which the first acoustic model 230 and the first language model 250 best match the feature vector string.

The first acoustic model 230 is applied to the calculation of an acoustic model score indicating a matching score between an input feature vector and a hidden Markov model (HMM) state, and the first language model 250 is applied to the calculation of a grammatical combination of neighboring words. As a result, N recognition sentences best matching the input feature vector string are searched for. In order to find the N recognition sentences, the Viterbi search algorithm or a stack decoder may be applied. As the search result of the first search unit 220, word lattices for obtaining a more accurate recognition result in the rescoring are generated. At this time, one of the plurality of generalized language models is selected as the first language model 250 according to the dialog history of a user and a system after the initial speech of the user, speech act information on the system speech contents, domain information, and information on the system prompt categories. For example, a global language model capable of covering all domains is applied to the initial speech of the user, and after the initial speech, the global language model is continuously applied or an appropriate language model is selected and applied according to the situations of dialog.

The first acoustic model 230 may be a speaker-independent acoustic model or a speaker-adaptive acoustic model that is adapted to the speech of the current user. In addition, the first language model 250 predicts the next word to appear, from previous words. Usually, a trigram, in which an estimate of the likelihood of a word is made solely on the identity of the preceding two words in the utterance, is used as the first language model 250, but this is not limited to the trigram.

The rescoring unit 260 receives the word lattices obtained from the first search unit 250, applies the first acoustic model 230 and the first language model 250, and outputs the final recognition result. At this time, in the rescoring unit 260, more detailed acoustic models and language models are applied. As for the detailed acoustic model, a between-words tri-phone model or quin-phone model can be used, and as for the detailed language model, a trigram or language-dependent rules can be applied. The final recognition result is N recognition sentences having high-level scores.

The phoneme recognition unit 270 receives the feature vectors from the feature extraction unit 210, and by using the second acoustic model 280 and the phoneme grammatical model 290 that are obtained in advance in the learning process, recognizes and outputs a phoneme string having a highest score. Also in the phoneme recognition unit 270, the same recognition algorithm as in the first speech recognition unit 210 is used.

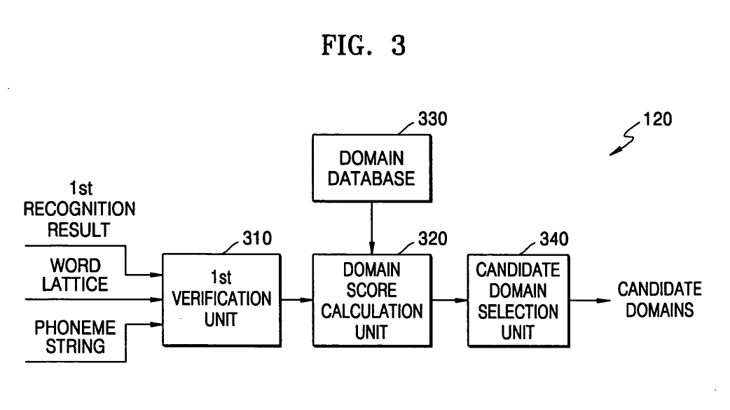

FIG. 3 is a block diagram showing a detailed structure of the domain extraction unit 120 in FIG. 1. The domain extraction unit 120 includes the first verification unit 310, a domain score calculation unit 320, a domain database 330, and a candidate domain selection unit 340.

Referring to FIG. 3, the first verification unit 310 performs word-level confidence score verification for the words included in each of the high-level N recognition sentences provided by the first speech recognition unit 110. The confidence score verification is performed by a verification method based on a likelihood ratio test (LRT) generally applied in hypothesis verification.

At this time, in a similarity ratio, the numerator is the score of a recognized word, and the denominator is the score of the phoneme recognition result in the phoneme recognition unit 270 in the recognized word interval, or the score of a word that is confused with the recognized word in an identical voice interval in the word lattice obtained in the first speech recognition unit 110. In addition, the confidence score of the current recognition sentence can be calculated from the confidence score of the remaining (N−1) recognition sentences. That is, the phoneme recognition result, the word lattice information, or the N recognition sentences is used in calculating a word-level confidence score, and in order to calculate a more accurate score, those three can be applied together. The first verification unit 310 performs the confidence score measuring process for the recognition words included in the N recognition sentences, determines words each having a confidence score equal to or higher than a predetermined threshold, and provides the words to the domain score calculation unit 320.

The domain score calculation unit 320 receives the verified words provided by the first verification unit 310, extracts keywords to be used for detecting a domain with reference to the domain database 330, and then calculates a recognition score of each of the keywords to a corresponding domain.

Usually a plurality of keywords are used in detecting domains, but there is a case where there are no domain keywords according to the verification result of the first verification unit 310. In order to calculate a domain score, a simple statistical domain detector using a domain unigram probability value for a domain keyword, or a support vector machine classifier can be used.

In the domain database 330, keywords are categorized by meaningful categories such as travel or weather, that is, by domains, and parameters required for estimating a probability value or for domain classification for each keyword. At this time, function words, such as auxiliary words or prefixes, are not included in domain keywords.

The candidate domain selection unit 340 receives the classification score for each domain provided by the domain score calculation unit 320, identifies domains having a highest classification score, and selects all domains having classification scores in a predetermined range from the highest score, as candidate domains. When there are no keywords applied to domain classification, all domains are selected as candidate domains.

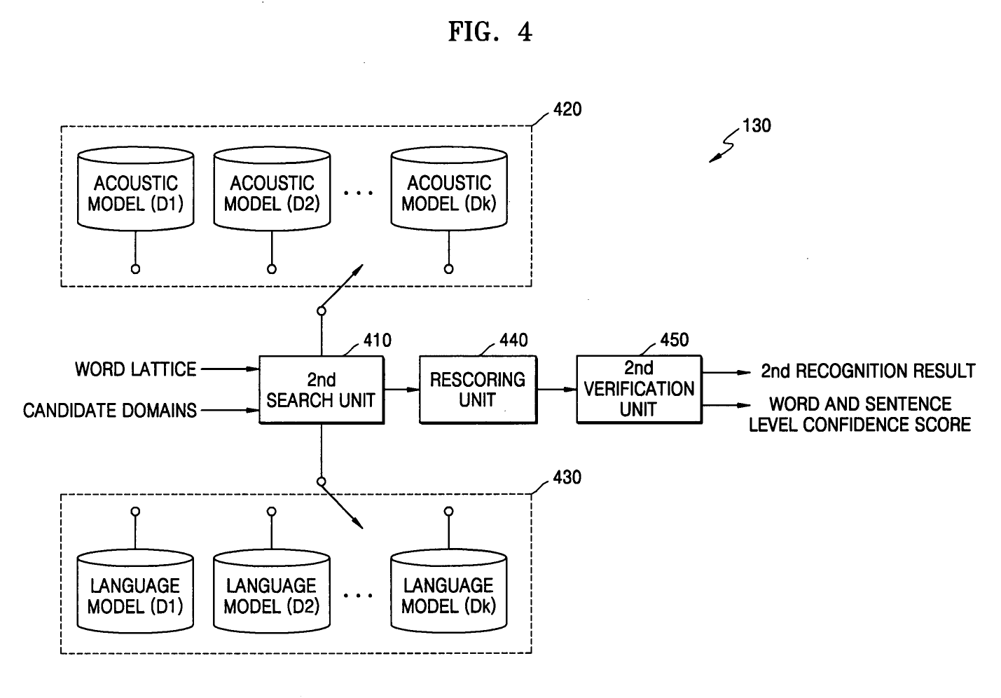

FIG. 4 is a block diagram showing a detailed structure of the second speech recognition unit 130 in FIG. 4. The second speech recognition unit 130 includes a second search unit 410, a rescoring unit 440, and a second verification unit 450.

Referring to FIG. 4, the second search unit 410 receives the word lattices or the word graph provided by the first speech recognition unit 110, and by using a language model 430 for each domain and an acoustic model 420 specific to each domain that are obtained in advance by learning and stored in the domain database 330, the second search unit 410 searches for N recognition sentences for each of the candidate domains. By limiting the object of the search process to the word lattices or the word graph, the amount of computation of the second search unit 410 is greatly reduced from that of the first search unit 210 of the first speech recognition unit 110.

The rescoring unit 440 performs rescoring of the plurality of N recognition sentences provided by the second search unit 410, by using a between-words tri-phone acoustic model or a trigram language model, generates a plurality of rescored recognition sentences and provides the plurality of recognized rescored sentences to the second verification unit 450.

The second verification unit 450 calculates word-level and sentence-level confidence score of the plurality of recognition sentences having high-level scores provided by the rescoring unit 440, to the selection unit 140.

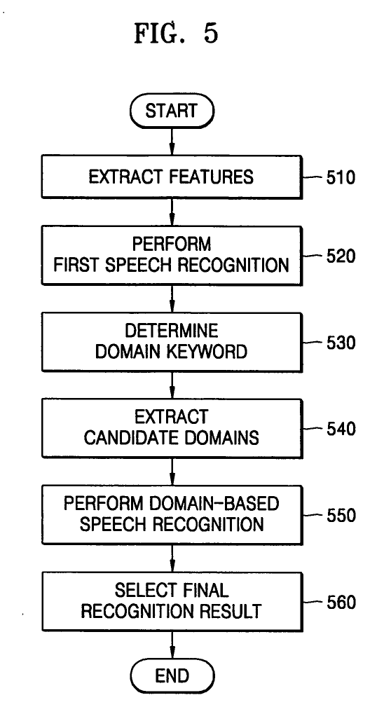

FIG. 5 is a flowchart of the operations performed by a domain-based speech recognition method according to an embodiment of the present invention.

Referring to FIG. 5, in operation 510, feature vectors are extracted from a sentence spoken by a user. As the feature vector, for example, a 26th-order feature vector formed with a 12th-order Mel-Frequency Cepstral Coefficient for each frame, a 12th-order delta Mel-Frequency Cepstral coefficient, energy and delta energy can be used.

In operation 520, by using the first acoustic model 230 and the first language model 250, speech recognition is performed and the first recognition result is generated. Here, the first recognition result includes one or more of N recognition sentences having high-level scores, the word lattice of all recognized sentences, and the phoneme string of all recognized sentences. The score of each recognition sentence is obtained by adding the log scores of the acoustic models and the log scores of the language models of words forming the sentence.

For example, it is assumed that when the sentence uttered by a user is [symbol] [symbol] [symbol] (“Jigeum kion i mieoch igi?” which means, “What is the temperature now?”), a high-level recognition sentence that can be included in the high-level N recognition sentences is [symbol] [symbol] [symbol] [symbol] (“Jigeum kion i mieoch shi gi?” which means, “What time is the temperature now?”—an exemplary incorrect sentence).

In operation 530, keywords used to select domains from the high-level N recognition sentences obtained in operation 520 are determined. Words each having a confidence score equal to or greater than a predetermined threshold and being a content word not a function word are determined as domain keywords among the words included in the high-level N recognition sentences. At this time, candidate domains are determined by domain unigram probability values or SVM scores of the domain keywords. For example, in the high-level recognition sentence [symbol] [symbol] [symbol] [symbol] (“Jigeum kion i mieoch shi gi?”), words are defined by each part of speech, and for a word corresponding to each part of speech, that is, [symbol] ([Jigeum]/nc) (now)”, “ [symbol] ([kion]/nc) (temperature)”, “ [symbol] ([i]jc)”, “ [symbol] ([mieoch]/m) (what)”, “ [symbol] ([shi]/nbu) (time)”, “ [symbol] ([ji]/ef )”, word-level confidence score are given as in the following table 1:

TABLE 1

| Word for each part of speech | Confidence score |
|---|---|
| [symbol] /nc (now) | −0.20 |
| [symbol] /nc (temperature) | 0.74 |
| [symbol] jc | 1.47 |
| [symbol] /m (what) | 0.48 |
| [symbol] /nbu (time) | 0.12 |
| [symbol] /ef | 1.39 |

In Table 1, [symbol] ([kion]/nc), [symbol] ([mieoch]/m), and [symbol] ([shi]/nbu), which have confidence scores over 0 and correspond to content words, are domain keywords. The keyword extraction process is also repeatedly performed for the remaining high-level (N−1) recognition sentences obtained as the result of first speech recognition in operation 520.

In operation 540, by using the domain keywords extracted from the high-level N recognition sentences determined in operation 530 as inputs, a plurality of candidate domains are extracted from the domain database 330. For example, in the above examples, the domain keyword [symbol] ([kion]/nc)” has a high probability value in the weather domain, and [symbol] ([shi]/nbu) has a high probability value in the “weather-time” domain. Accordingly, in the above example, the “weather” domain and “weather-time” domain are selected as candidate domains.

In operation 550, by using an acoustic and language model specific to each of the plurality of candidate domains extracted in operation 540, speech recognition is performed. At this time, speech recognition is performed with the word lattices obtained in operation 520 or the word graph obtained by compactly compressing the word lattice.

In the above example, with the high-level recognition sentence [symbol] [symbol] [symbol] [symbol] (“Jigeum kion i mieoch shi gi?”), speech recognition is performed by applying an acoustic model and a language model specific to the candidate domain on “weather”, and a second recognition sentence, that is, [symbol] [symbol] [symbol] (“Jigeum kion i mieoch igi?”) (What is the temperature now?), is generated and the score is calculated. Also, speech recognition is performed by applying an acoustic model and a language model specific to the candidate domain on “weather-time”, and a second recognition sentence, that is, [symbol] [symbol] [symbol] (“Jigeum shigan i mieoch shi gi?”) (What time is it now?)”, is generated and the score is calculated. This speech recognition process based on the candidate domains is performed for all candidate domains extracted in operation 540. At this time, the number of candidate domains is 1 at the minimum and the number of the entire domains at the maximum. Whenever speech recognition is performed for a candidate domain, a language model specific to the domain is switched on and read from a corresponding hardware module. When the number of the entire domains is small, language models of all domains may be loaded on a program such that when necessary, a language model is switched on.

In operation 560, the scores of the high-level N recognition sentences obtained in operation 520 are compared with the scores of the plurality of the second recognition sentences obtained in operation 550, and a plurality of final recognition sentences are selected. In the above example, the scores of the high-level N recognition sentences, including the high-level recognition sentence [symbol] [symbol] [symbol] [symbol] (“Jigeum kion i mieoch shi gi?”), are compared with the scores of the plurality of domain-based recognition sentences, including [symbol] [symbol] [symbol] (“Jigeum kion i mieoch igi?”) and [symbol] [symbol] [symbol] (“Jigeum shigan i mieoch shi gi?”), and final recognition sentences, including the domain-based recognition sentence having the highest score, [symbol] [symbol] [symbol] (“Jigeum kion i mieoch igi?”) are generated.

The invention can also be embodied as computer-readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion. Also, functional programs, codes, and code segments for accomplishing the present invention can be easily construed by programmers skilled in the art to which the present invention pertains.

Meanwhile, simulations to evaluate the performance of the speech recognition method according to the present invention have been performed as follows. As the acoustic model learning data, reading style continuous speech sentences spoken by a total of 456 persons, including 249 males and 207 females, were used. Each speaker spoke about 100 sentences. As the language model learning data, a text database of about 18 million sentences related to 18 domains was used. As test data, 3000 sentences spoken by 15 males and 15 females were used. As the feature vector, the 26th-order feature vector, formed with 12th-order MFCC, 12th-order delta MFCC, energy and delta energy, was used. The learned HMM model was 4,016 tri-phone models. Similar HMM states shared parameters and the number of distinguished HMM states was 5,983. Each HMM state is characterized by a statistical distribution based on a phonetically-tied mixture model.

In the first speech recognition, the global language model was used. Comparison objects included a method using a language model with a three-layered structure, a method for detecting a keyword based on unigram similarity, a method for performing speech recognition in a plurality of domains in parallel, and the speech recognition method of the present invention. In an embodiment of the present invention, as the acoustic model, an identical speaker-independent model was used for both the first and the second speech recognition processes. In the first speech recognition process, the global language model was applied. The confidence score of the recognition result applied to selection of a domain keyword was calculated by obtaining the difference between the log score of a recognized word and the phoneme recognition log score recognized in the voice interval of the word. In selecting a candidate domain, the domain classification score using a unigram probability for the domain of each domain keyword was compared with a highest domain classification score, and all domains having the domain classification score in a predetermined range from the highest domain classification score were selected as candidate domains. Language models corresponding to a total of 18 domains were used.

The simulation results on the domain detection accuracy showed that the accuracy of detection by the texts used for evaluation was 93.8%, the accuracy of detection when the highest-level recognition result was used in the first speech recognition process was 88.2%, the accuracy of detection when only the result relied on in the first speech recognition process was 90.3%, and the accuracy of domain determination measured from the recognition result of the second speech recognition process was 96.5%. The number of average domains searched for in the second speech recognition process was 3.9. At this time recognition performances are as shown in the following table 2:

TABLE 2

| | WER (bigram) | WER (trigram) |
|---|---|---|
| Baseline | 8.79 | 4.40 |
| (Global language model) | | |
| Conventional method 1 | 7.57 | 4.08 |
| (Layered language model) | (+13.9) | (+7.3) |
| Conventional method 2 | 5.73 | 3.70 |
| (Parallel speech recognition | (+34.8) | (+15.9) |
| of 18 domains) | | |
| Present invention | 6.23 | 3.72 |
| | (+29.1) | (+15.5) |

In Table 2, WER denotes a word-error ratio, and a number in ( ) shows a relative improvement ratio of a word-error ratio. The language models applied to the performance evaluation were a bigram language model indicating a probability between neighbouring two words, and a trigram language model indicating a probability among neighbouring three words.

According to table 2, the speech recognition method according to an embodiment of the present invention shows a great performance improvement compared to the method using the global language model, and the method using the layered language model. Compared to the method performing speech recognition in parallel for all domains having respective specific language models, the present invention shows almost the same performance without using a large capacity server, and if the number of domains is greater than the number of microprocessors, the speech recognition speed of the present invention is expected to be higher.

According to an embodiment of the present invention as described above, a language model appropriate to the situation of conversion is selectively applied in the first speech recognition process such that the word error rate in the first recognition result can be reduced and as a result, accurate keywords used for extracting domains can be determined.

Also, by generating a plurality of high-level recognition sentences including the highest level recognition sentence as the result of the first speech recognition process, propagation of errors in the first recognition result to the following process can be minimized. In addition, a plurality of candidate domains are extracted based on keywords determined in respective recognition sentences, the second speech recognition is performed by using the language model specific to each candidate domain, and the final recognition result is generated from the both of the first and second speech recognition results. By doing so, the effect of domain extraction errors caused by misrecognition of a word in the first speech recognition process, on selection of the final recognition result can be minimized.

Although a few embodiments of the present invention have been shown and described, it would be appreciated by those skilled in the art that changes may be made in this embodiment without departing from the principles and spirit of the invention, the scope of which is defined in the claims and their equivalents.

1. A domain-based dialog speech recognition method comprising:
performing speech recognition by using a first language model and generating a first recognition result including a plurality of first recognition sentences;
selecting a plurality of candidate domains, by using a word included in each of the first recognition sentences and having a confidence score equal to or higher than a predetermined threshold, as a domain keyword;
performing the speech recognition with the first recognition result, by using an acoustic model specific to each of the candidate domains and a second language model and generating a plurality of second recognition sentences; and
selecting one or more final recognition sentences from the first recognition sentences and the second recognition sentences.

2. The method of claim 1, wherein a global language model is applied as the first language model.

3. The method of claim 1, wherein in the initial stage, a global language is applied as the first language model, and according to a situation of dialog, one of a plurality of generalized language models is selectively applied.

4. The method of claim 1, wherein in selecting the plurality of candidate domains, a classification score of each of the candidate domains is calculated by using keywords each keyword having the confidence score equal to or greater than the predetermined threshold in the plurality of the first recognition sentences, and selecting as the candidate domains, the candidate domains having a classification score equal to or greater than a predetermined threshold.

5. The method of claim 1, wherein in selecting the plurality of candidate domains, if there is no keyword having the confidence score equal to or greater than the predetermined threshold in the plurality of the first recognition sentences, the entire plurality of candidate domains are selected as the candidate domains.

6. The method of claim 1, wherein in generating the plurality of second recognition sentences, speech recognition is performed with any one of word lattices and a word graph among the first recognition result.

7. A computer-readable recording medium having embodied thereon a computer program sequence for a domain-based dialog speech recognition method comprising:
performing speech recognition by using a first language model and generating a first recognition result including a plurality of first recognition sentences;
selecting a plurality of candidate domains, by using a word included in each of the first recognition sentences and having a confidence score equal to or higher than a predetermined threshold, as a domain keyword;
performing the speech recognition with the first recognition result, by using an acoustic model specific to each of the candidate domains and a second language model, and generating a plurality of second recognition sentences; and
selecting one or more final recognition sentences from the first recognition sentences and the second recognition sentences.

8. A domain-based dialog speech recognition apparatus comprising:
a first speech recognition unit which performs speech recognition of input speech by using a first language model and generates a first recognition result including a plurality of first recognition sentences;
a domain extraction unit which selects a plurality of candidate domains by using the plurality of first recognition sentences provided by the first speech recognition unit;
a second speech recognition unit which performs the speech recognition with the first recognition result of the first speech recognition unit, by using an acoustic model specific to each of the candidate domains selected in the domain extraction unit and a second language model and generates a plurality of second recognition sentences; and
a selection unit which selects a plurality of final recognition sentences from the first recognition sentences provided by the first speech recognition unit and the second recognition sentences provided by the second speech recognition unit.

9. The apparatus of claim 8, wherein in the first speech recognition unit, a global language model is applied as the first language model.

10. The apparatus of claim 8, wherein in the first speech recognition unit, a global language is applied as the first language model in an initial stage, and according to a situation of dialog, one of a plurality of generalized language models is selectively applied.

11. The apparatus of claim 8, wherein the domain extraction unit comprises:
a first verification unit which performs word-level confidence score verification for the plurality of the recognition sentences provided by the first speech recognition unit, and extracts verified words each having a confidence score equal to or greater than a predetermined threshold from each of the first recognition sentences;
a domain score calculation unit which selects domain keywords among the verified words provided by the first verification unit with reference to a domain database, and by calculating and adding up domain classification scores of respective keywords, calculates a classification score for each domain; and
a candidate domain selection unit which selects a domain having a classification score equal to or greater than a predetermined threshold among classification scores for respective domains provided by the domain score calculation unit.

12. The apparatus of claim 11, wherein the first verification unit performs word-level confidence score verification of the plurality of the first recognition sentences by using part or all of the plurality of first recognition sentences, word lattices, word graphs obtained by compressing the word lattices, and phoneme strings provided by the first speech recognition unit.

13. The apparatus of claim 8, wherein by using a language model specific to each of the candidate domains and an acoustic model adapted to the language model, the second speech recognition unit recognizes any one of a word lattice and a word graph provided by the first speech recognition unit, and then, by performing rescoring, generates the second recognition sentences.

14. The apparatus of claim 8, wherein the first recognition result generated by the first speech recognition unit includes word lattices, high-level N recognition sentences, word graphs, phoneme strings and syllable strings.

15. The apparatus of claim 8, wherein the first speech recognition unit includes a feature extraction unit, a first search unit, a rescoring unit, and a phoneme unit.

16. The apparatus of claim 15, wherein the feature extraction unit receives a speech signal input, and converts the speech signal input into feature vectors for the speech recognition.

17. The apparatus of claim 16, wherein the first search unit receives the feature vectors from the feature extraction unit, and by using a first acoustic model, a pronunciation dictionary, and a first language model, finds a word string in which the first acoustic model and the first language model match the feature vector string.

18. The apparatus of claim 17, wherein the first acoustic model is a speaker-independent acoustic model or a speaker-adaptive acoustic model adapted to the speech of a user.

19. The apparatus of claim 15, wherein the rescoring unit receives word lattices from the first search unit, applies a first acoustic model and a first language model and outputs the first recognition result.

20. The apparatus of claim 19, wherein the first acoustic model includes a between-words tri-phone model and a quin-phone model and the first language model includes a trigram and a language-dependent rule.

21. The apparatus of claim 8, wherein the second speech recognition unit comprises:
a second search unit receiving word lattices or a word graph provided by the first speech recognition unit and searches for N recognition sentences for each of the candidate domains;
a rescoring unit performing rescoring of the N recognition sentences and by using a between-words tri-phone acoustic model or a trigram language model, generates a plurality of rescored recognition sentences;
a verification unit calculating word-level and sentence-level confidence score of the plurality of rescored recognition sentences.

22. The apparatus of claim 21, wherein the trigram language model makes an estimate of a likelihood of a next word based on an identity of two preceding words.

23. The apparatus of claim 21, wherein by limiting a search process to the word lattices or to the word graphs, a computation amount of the second search unit is reduced compared to a first search unit.

24. The method of claim 1, wherein by generating a plurality of high-level recognition sentences including a highest level recognition sentence as result of a first speech recognition process, propagation of errors in a first recognition result is minimized.

25. The method of claim 1, wherein the plurality of candidate domains are extracted based on the words determined in the first and second recognition sentences, a second speech recognition is performed using a language model specific to each of the candidate domains, and a final recognition result is generated from the first and second speech recognition results.
